(19) United States
(12) Patent Application Publication
(10) Pub. No.: US 2025/0200729 A1
(43) Pub. Date: Jun. 19, 2025

(54) METHOD AND DEVICE FOR RESTORING VIDEO

(71) Applicant: KOREA ADVANCED INSTITUTE OF SCIENCE AND TECHNOLOGY, Daejeon (KR)

(72) Inventors: Munchurl KIM, Daejeon (KR); Geunhyuk YOUK, Daejeon (KR)

(21) Appl. No.: 18/981,056

(22) Filed: Dec. 13, 2024

Related U.S. Application Data
(60) Provisional application No. 63/612,372, filed on Dec. 20, 2023.

(30) Foreign Application Priority Data
Dec. 14, 2023 (KR) 10-2023-0181432
Dec. 5, 2024 (KR) 10-2024-0179843

(51) Int. Cl. G06T 5/73; G06T 3/18; G06T 5/20; G06T 5/50; G06T 7/20

(52) U.S. Cl. CPC G06T 5/73; G06T 3/18; G06T 5/20; G06T 5/50; G06T 7/20; G06T 2207/10016; G06T 2207/20084; G06T 2207/20201; G06T 2207/30168

(57) ABSTRACT

A method and device for restoring a video are disclosed. The method of restoring a video includes obtaining a plurality of blurred images due to the motion of an object captured in the video. The method includes generating a first kernel including degradation information on the plurality of blurred images, optical flow information on a moving direction of the object, and first motion information of the object included in the plurality of blurred images, based on the plurality of blurred images included in the video. The method includes generating dynamic filtering information to filter the plurality of blurred images, based on the plurality of blurred images, the first motion information, the optical flow information, and the first kernel. The method includes restoring a target image to be restored among the plurality of blurred images, based on the dynamic filtering information and the plurality of blurred images.

### CROSS-REFERENCE TO RELATED APPLICATION(S)

This application claims the priority benefit of Korean Patent Application No. 10-2023-0181432 filed on Dec. 14, 2023, in the Korean Intellectual Property Office, U.S. Provisional Application No. 63/612,372 filed on Dec. 20, 2023, in the U.S. Patent and Trademark Office, and Korean Patent Application No. 10-2024-0179843 filed on Dec. 5, 2024, in the Korean Intellectual Property Office, the disclosures of which are incorporated herein by reference for all purposes.

### BACKGROUND

### 1. Field

One or more embodiments relate to a method and device for restoring a video.

### 2. Description of Related Art

Video super-resolution (VSR) aims to restore a high-resolution (HR) video from a given low-resolution (LR) video. In various situations, given videos may be blurred or qualitatively deteriorated due to camera shakes or object motions. This is referred to as motion blur.

In the field of video prediction, a dynamic filter may be used to restore an HR video from an LR video with motion blur.

The above description has been possessed or acquired by the inventor(s) in the course of conceiving the present disclosure and is not necessarily an art publicly known before the present application is filed.

### SUMMARY

Aspects provide technology for warping a plurality of images included in a video based on optical flow information.

Aspects provide technology for restoring a target image to be restored by filtering the warped images obtained by warping the plurality of the blurred images in the video.

Aspects provide technology for restoring a target image to be restored based on optical flow information.

However, technical aspects are not limited to the foregoing aspects, and there may be other technical aspects.

According to an aspect, there is provided a method of restoring a video including obtaining a plurality of blurred images due to object motion or camera motion captured in the video. The method may include generating a first kernel including degradation information on the plurality of blurred images, optical flow information on the object motion direction or camera motion direction, and first motion information of the plurality of blurred images included in the video. The method may include generating dynamic filtering information to filter the plurality of blurred images, based on the plurality of blurred images, the first motion information, the optical flow information, and the first kernel.

The generating of the dynamic filtering information may include generating second motion information to adjust the optical flow information, based on the plurality of blurred images and the first motion information. The generating of the dynamic filtering information may include adjusting the optical flow information, based on the second motion information, the optical flow information, and the first kernel. The generating of the dynamic filtering information may include generating distorted information on how distorted each of the remaining images excluding the target image is with respect to the target image, based on the second motion information, the optical flow information, and the first kernel. The dynamic filtering information may include adjusted optical flow information and the distorted information.

The restoring of the target image may include restoring the target image by filtering the plurality of blurred images, based on the adjusted optical flow information and the distorted information.

The restoring of the target image may further include warping each of the plurality of blurred images, based on the adjusted optical flow information. The restoring of the target image may further include generating a second kernel to filter warped images obtained by warping the each of the plurality of blurred images, based on the distorted information. The restoring of the target image may further include restoring the target image by filtering the warped images using the second kernel.

The restoring of the target image by filtering the warped images using the second kernel may include restoring low-frequency components of the target image.

The method may further include restoring high-frequency components of the target image, based on the distorted information.

According to another aspect, there is provided an electronic device including a memory including instructions and a processor electrically connected to the memory and configured to execute the instructions. The instructions, when executed by the processor, may cause the electronic device to obtain a plurality of blurred images due to object motion or camera motion captured in a video. The instructions, when executed by the processor, may cause the electronic device to generate a first kernel including degradation information on the plurality of blurred images, optical flow information on object motion directions, and first motion information of the each of the plurality of blurred images, based on the plurality of blurred images included in the video. The instructions, when executed by the processor, may cause the electronic device to generate dynamic filtering information to filter the plurality of blurred images, based on the plurality of blurred images, the first motion information, the optical flow information, and the first kernel. The instructions, when executed by the processor, may cause the electronic device to restore a target image to be restored among the plurality of blurred images, based on the dynamic filtering information and the plurality of blurred images.

The instructions, when executed by the processor, may cause the electronic device to generate second motion information to adjust the optical flow information, based on the plurality of blurred images and the first motion information. The instructions, when executed by the processor, may cause the electronic device to adjust the optical flow information, based on the second motion information, the optical flow information, and the first kernel. The instructions, when executed by the processor, may cause the electronic device to generate distorted information on how distorted each of the remaining images excluding the target image is with respect to the target image, based on the second motion information, the optical flow information, and the first kernel.

The instructions, when executed by the processor, may cause the electronic device to restore the target image by filtering the plurality of blurred images, based on adjusted optical flow information and the distorted information.

The instructions, when executed by the processor, may cause the electronic device to warp the each of the plurality of blurred images, based on the adjusted optical flow information. The instructions, when executed by the processor, may cause the electronic device to generate a second kernel to filter warped images obtained by warping the each of the plurality of blurred images, based on the distorted information. The instructions, when executed by the processor, may cause the electronic device to restore the target image by filtering the warped images using the second kernel.

The instructions, when executed by the processor, may cause the electronic device to restore low-frequency components of the target image.

The instructions, when executed by the processor, may cause the electronic device to restore high-frequency components of the target image, based on the distorted information.

### BRIEF DESCRIPTION OF THE DRAWINGS

FIG. 1 is a block diagram illustrating a device for restoring a video, according to an embodiment.

FIG. 2 is a diagram illustrating the internal structure of a first neural network for generating a degraded image due to an optical flow, according to an embodiment.

FIG. 3 is a diagram illustrating the internal structure of an optical flow estimator included in a first neural network, according to an embodiment.

FIG. 4 is a diagram illustrating the internal structure of a second neural network for restoring a video, according to an embodiment.

FIG. 5 is a diagram illustrating the internal structure of an optical flow estimator included in a second neural network, according to an embodiment.

FIG. 6 is a diagram illustrating the structure of a flow-guided dynamic filter (FGDF), according to an embodiment.

FIG. 7 is a flowchart illustrating a method of restoring a video, according to an embodiment.

FIG. 8 is a block diagram illustrating a video restoration unit according to an embodiment.

### DETAILED DESCRIPTION

The following detailed structural or functional description is provided as an example only and various alterations and modifications may be made to the examples. Here, the embodiments are not construed as limited to the disclosure and should be understood to include all changes, equivalents, and replacements within the idea and the technical scope of the disclosure.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

As used herein, the singular forms “a”, “an”, and “the” include the plural forms as well, unless the context clearly indicates otherwise. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto will be omitted.

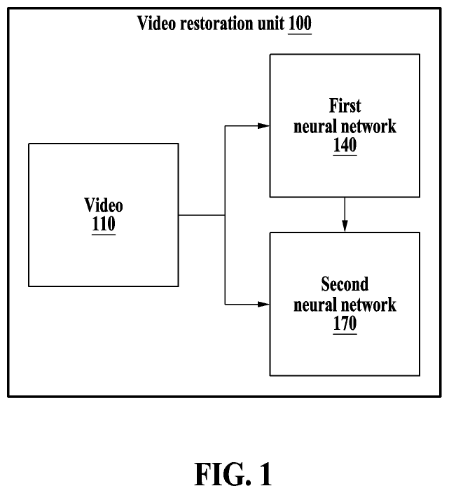

FIG. 1 is a block diagram illustrating a device for restoring a video, according to an embodiment.

Referring to FIG. 1, according to an embodiment, a video restoration unit 100 may include a first neural network 140 and/or a second neural network 170.

The video restoration unit 100 may be a unit for restoring a video. The video restoration unit 100 may receive a video 110 to restore a high-quality (or high-resolution) video from a low-quality (or low-resolution) video. The video 110 may include a plurality of blurred images. The plurality of blurred images may include a series of low-resolution images. For example, the plurality of blurred images may be images including motion blur. The video restoration unit 100 may perform super-resolution on the plurality of blurred images included in the video 110.

The super-resolution refers to video processing that transforms an input image with low spatial resolution into an input image with high spatial resolution. The video restoration unit 100 may perform super-resolution on the video 110 or the plurality of blurred images included in the video 110 by using a neural network (e.g., the first neural network 140 or the second neural network 170).

The video 110 may include a plurality of temporal portions. One temporal portion corresponds to a group of frames during one certain temporal duration, that is, one video clip which is usually a part (the certain temporal duration) of a longer recording. The video may include scenes of multiple temporal durations over time. The first neural network 140 may receive the video 110. The video 110 input to the first neural network 140 may include the plurality of blurred images due to the motions of the captured object and/or a plurality of sharp images corresponding to the plurality of blurred images. The plurality of blurred images may be degraded images due to the motions of the captured object, and the plurality of sharp images may be sharp images without object motions. The plurality of blurred images and the plurality of sharp images may each correspond to the same point in time.

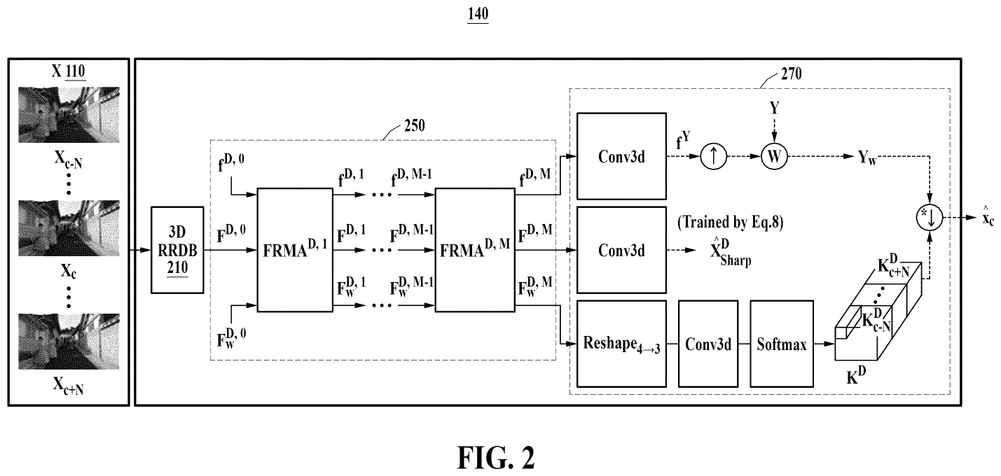

The first neural network 140 may receive the video 110 and may generate a degraded image due to an optical flow. The first neural network 140 may receive the video 110 and may be trained to generate a degraded image due to an optical flow. The internal structure of the first neural network 140 and the training to generate a degraded image are described in detail with reference to FIG. 2.

The video restoration unit 100 may be pre-trained such that the first neural network 140 generates a degraded image. The first neural network 140 pre-trained to generate a degraded image may generate a first kernel (e.g., a first kernel K^{D} of FIG. 2) including degradation information on blurred images X, optical flow information (e.g., optical flow information f^{D,M} of FIG. 2), and/or first motion information (e.g., first motion information F^{D,M} of FIG. 2) of the plurality of the blurred images in the video 110. The video restoration unit 100 may transmit the first motion information F^{D,M}, the optical flow information f^{D,M}, and/or the first kernel K^{D} generated from the first neural network 140 to the second neural network 170. The video restoration unit 100 may use the first motion information F^{D,M}, the optical flow information f^{D,M}, and/or the first kernel K^{D} generated from the first neural network 140 to train the second neural network 170.

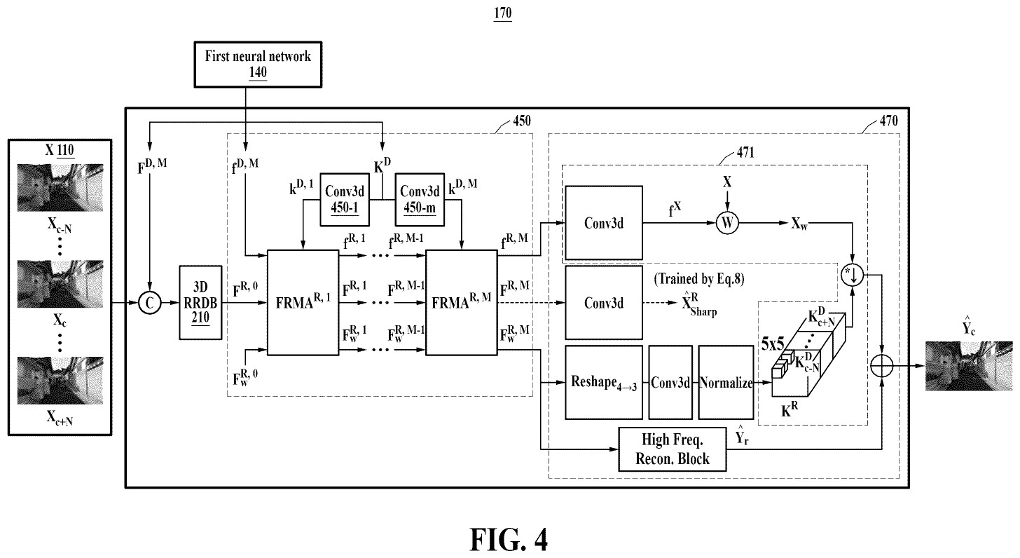

The video 110 input to the second neural network 170 may be the same video input to the first neural network 140. The second neural network 170 may receive the first motion information F^{D,M}, the optical flow information f^{D,M}, and/or the first kernel K^{D} generated from the first neural network 140 and the video 110 and may restore the video 110. The internal structure of the second neural network 170 and the training to restore a video are described in detail with reference to FIG. 4.

A neural network (or an artificial neural network) may include a statistical learning algorithm that mimics biological nerves in cognitive science and machine learning. Neural networks may refer to general models having problem-solving capabilities, in which artificial neurons (nodes) forming a network through synapse coupling change the intensity of the connection between synapses through training.

The neural network (e.g., the first neural network 140 and/or the second neural network 170) may include a deep neural network. The neural network may include a convolutional neural network (CNN), a recurrent neural network (RNN), a perceptron, a multilayer perceptron, a feed forward (FF), a radial basis network (RBF), a deep feed forward (DFF), a long short-term memory (LSTM), a gated recurrent unit (GRU), an auto encoder (AE), a variational auto-encoder (VAE), a denoising auto-encoder (DAE), a sparse auto-encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a visual geometry group (VGG) network, and an attention network (AN).

FIG. 2 is a diagram illustrating the internal structure of a first neural network for generating a degraded image due to an optical flow, according to an embodiment.

Referring to FIG. 2, according to an embodiment, the first neural network 140 may be pre-trained to train a second neural network (e.g., the second neural network 170 of FIG. 1). The first neural network 140 may simultaneously perform video super-resolution and deblurring (VSRDB). The first neural network 140 may be a part of a degradation learning network of FMA-net, which is the architecture of a VSRDB framework. The first neural network 140 may predict motion-aware spatiotemporally variant degradation.

The first neural network 140 may receive a plurality of blurred images X included in the video 110. The plurality of blurred images X may be expressed by X={X_{c-N:c+N}}∈R^{T×H×W×3} T is 2N+1 and may be the number of the plurality of blurred images X input to the first neural network 140. A target image X_{c} 111 among the plurality of blurred images X may be an N+1th blurred image of a series of the input 2N+1 blurred images. The target image X_{c} may be a center blurred image among a series of input image layers. The target image X_{c} may be a blurred image to be restored. A blurred image X_{C-N} may include blurred images temporally prior to the target image X_{c}. A blurred image X_{C+N} may include blurred images temporally later than the target image X_{c}. The blurred images excluding the target image X_{c} may be the blurred images X_{C-N} and X_{C+N} (or the remaining images X_{C-N} and X_{C+N}).

The first neural network 140 may include a feature extractor 210, an optical flow estimator 250, and/or a degraded image generator 270.

The feature extractor 210 may obtain initial motion information F^{D,0} of the video 110, based on the video 110 input to the first neural network 140. For example, the feature extractor 210 may extract the initial motion information F^{D,0} of the blurred images X. The feature extractor 210 may include a three-dimensional residual-in-residual dense block (3D RRDB). Immediately obtaining a degraded image \hat{X}c 271 based on the initial motion information F^{D,0} may be unstable for obtaining a degraded image and may incur a great deal of computational costs. The feature extractor 210 may transmit (or relay) the extracted initial motion information F^{D,0} to the optical flow estimator 250.

The optical flow estimator 250 may generate optical flow information f^{D,M} on an object motion direction or camera motion direction included in the blurred images X of the video 110, based on the received (or relayed) initial motion information F^{D,0} from the feature extractor 210.

The optical flow estimator 250 may include a plurality of feature refinement with multi-attention (FRMA) blocks FRMA^{D,1} to FRMA^{D,M}. The optical flow estimator 250 may input the initial motion information F^{D,0} to a first FRMA block FRMA^{D,1} among the plurality of FRMA blocks FRMA^{D,1} to FRMA^{D,M}. For example, the optical flow estimator 250 may include M FRMA blocks. The FRMA blocks FRMA^{D,1} to FRMA^{D,M} may iteratively refine initial optical flow information f,0 and/or the initial motion information F^{D,0} in a residual learning manner. The FRMA blocks FRMA^{D,1} to FRMA^{D,M} may learn the initial optical flow information f^{D,0} and an occlusion mask corresponding to the initial optical flow information f^{D,0}.

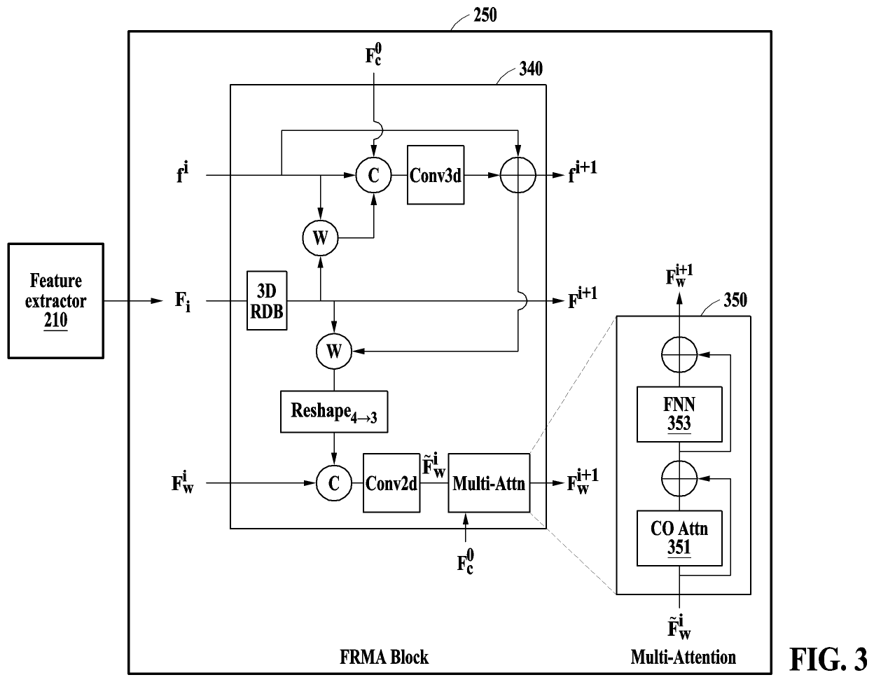

The video restoration unit 100 may acquire flow diversity by learning the FRMA blocks FRMA^{D,1} to FRMA^{D,M} based on the initial optical flow information f^{D,0} and the occlusion mask corresponding to the initial optical flow information f^{D,0}. The video restoration unit 100 may learn the one-to-many relationship between the pixel of the target image X_{C} and the pixels of the remaining images X_{C-N} and X_{C+N}, based on the initial optical flow information f^{D,0} and the occlusion mask corresponding to the initial optical flow information f^{D,0}. The video restoration unit 100 may learn the relationship between the blurred images X where their pixel information has been spread due to light accumulation, based on the initial optical flow information f^{D,0} and the occlusion mask corresponding to the initial optical flow information f^{D,0}. The internal structure of the FRMA blocks FRMA^{D,1} to FRMA^{D,M} and the process of the initial optical flow information f^{D,0} and/or the initial motion information F^{D,0} being iteratively refined by the FRMA blocks FRMA^{D,1} to FRMA^{D,M} are described with reference to FIG. 3.

The optical flow estimator 250 may acquire the optical flow information f^{D,M}, the first motion information F^{D,M}, and/or distorted information F_{W}^{D,M} based on initial distorted information F_{W}^{D,0} on how distorted the initial optical flow information f^{D,0}, the initial motion information F^{D,0}, and the target image X_{C} are compared to each of the remaining images X_{C-N} and X_{C+N}. The optical flow estimator 250 may transmit (or relay) the acquired optical flow information f^{D,M}, the acquired first motion information F^{D,M}, and/or the acquired distorted information F_{W}^{D,M} to the degraded image generator 270.

The degraded image generator 270 may generate the first kernel K^{D} based on the received (or relayed) distorted information F_{W}^{D,M}. The first kernel K^{D} may be guided by the optical flow information f^{D,M} and may be dynamically generated to be aware of a motion pixel-wise. The first kernel K^{D} that is guided by the optical flow information f^{D,M} may effectively process the motion of the object included in the video even with a small size. The degraded image generator 270 may acquire filtering results by using the first kernel K^{D} through Equation 1.

$$y ( p ) = {\sum }_{t = - N}^{+ N} {\sum }_{k = 1}^{{n}^{2}} {F}_{c + t}^{p} ( {p}_{k} ) \cdot {x}_{c + t}^{′} ( p + {p}_{k} ) \qquad [ Equation 1 ]$$

Here, y (p) denotes an output value at a position p, a range from t=−N to t=+N is 2N+1, that is, the number of input images, a range from k=1 to k=n² is the size of an n×n kernel, F_{c+t}^{p}(pₖ) denotes a kernel value in a c+tth input image included in the input images, x′_{c+t} is W(x_{c+t}, f_{c+t}), and p+pₖ denotes a position moving from the position p by pₖ, that is, the position of the first kernel K^{D}. W(x_{c+t}, f_{c+t}) denotes a warping operation using the c+tth input image, X_{c+t} denotes the c+tth input image, f_{c+t} denotes an occlusion mask and optical flow information of the c+tth input image for a center image among the input images.

Based on the optical flow information f^{D,M}, the degraded image generator 270 may obtain an image flow mask f^{Y} for sharp images Y. The image flow mask f^{Y} may include information on the object motion direction or camera motion direction in the sharp images Y. The image flow mask f may include information on a part hidden (or occluded) by the motion of the object. The information on the hidden (or occluded) part may be information on an occlusion mask. The size of a patch of the image flow mask f^{Y} may be f^{Y}∈ [symbol] ^{T×H×W×(2+1)}. Here, T denotes the number of input images, H denotes the height of the patch, W denotes the width of the patch, and 2+1 denotes a combination of 2 denoting the optical flow information of the sharp images Y and 1 denoting the information of a current sharp image among the sharp images Y.

Based on the image flow mask f^{Y} obtained based on the optical flow information f^{D,M}, the degraded image generator 270 may warp the sharp images Y. The degraded image generator 270 may generate warped images Y_{w} where the object included in each of the sharp images Y is warped.

The degraded image generator 270 may filter the warped images Y_{w} through the first kernel K^{D}. The degraded image generator 270 may obtain a degraded image Åc by filtering the warped images Y_{w} through the first kernel K^{D}. The size of the patch of the first kernel K^{D} may be K^{D}∈ [symbol] ^{T×H×W×k}^{_{d}}^{²}. Here, k_{d} may be the size of the first kernel K^{D}. The first kernel K^{D} may have been normalized by using a SoftMax function. The first kernel K^{D} may mimic a blur generation process where all kernels have positive values.

The first kernel K^{D} may include degradation information on the blurred images X. The degradation information may be information on degradation (blur and/or low-resolution) included in the blurred images X. Based on the degradation information included in the first kernel K^{D}, the degraded image generator 270 may obtain (or generate) a degraded image \hat{X}c from the warped images Y_{w}.

The degraded image generator 270 may obtain the degraded image \hat{X}c through Equation 2.

$${\hat{X}}_{c} = ( w ( Y , s \cdot ( {f}^{Y} {↑}_{{}^{s}} ) ) {K}^{D} ) {↓}_{s} \qquad [ Equation 2 ]$$

Here, \textcircled{*}↓ₛ denotes dynamic filterling performed by moving the first kernel K^{D} at every interval s at the position of each pixel according to Equation 1, and ↑ₛ denotes s times bilinear upsampling.

Based on the first motion information F^{D,M}, the degraded image generator 270 may generate a sharp image \hat{X}ₛₕₐᵣₚ^{D} by removing degradation included in the blurred images X. For example, the degraded image generator 270 may generate the sharp image \hat{X}ₛₕₐᵣₚ^{D} by mapping the first motion information F^{D,M} to an image domain via 3D convolution. The sharp image \hat{X}ₛₕₐᵣₚ^{D} may be used to train the first neural network 140. The sharp image \hat{X}ₛₕₐᵣₚ^{D} may be an intermediate output.

The first neural network 140 may be trained based on a loss L_{D}. The loss L_{D} may be obtained through Equation 3.

$${L}_{D} = {l}_{1} ( {\hat{X}}_{c} , {X}_{c} ) + {λ}_{1} {\sum }_{- N}^{+ N} {l}_{1} ( W ( {Y}_{t + c} , s \cdot ( {f}_{t + c}^{Y} {↑}_{s} ) ) , {Y}_{c} ) + {λ}_{2} {l}_{1} ( {f}^{Y} , {f}_{RAFT}^{Y} ) + {λ}_{3} {l}_{1} ( {\hat{X}}_{Sharp}^{{}_{D}} , {X}_{Sharp} ) \qquad [ Equation 3 ]$$

Here, f^{Y} denotes an optical flow included in the image flow mask f, f_{RAFT}^{Y} denotes a pseudo-ground truth (GT) optical flow generated by a pre-trained RAFT model, and, X_{Sharp} denotes a sharp low-resolution image obtained by applying bicubic downsampling to the sharp images Y.

The first term of the right side of Equation 3 may be a reconstruction loss. The second term may be a warping loss for optical flow learning from the center image Y_{c} to the remaining images Y_{t+c} among the sharp images Y. The third term may be a loss using RAFT pseudo-GT for minutely adjusting an optical flow. The fourth term may temporally anchor each of features included in motion information F^{D} to a corresponding image and may be a temporal anchor loss that sharpens the motion information F^{D}. The temporal anchor loss may distinguish distorted information from non-distorted information of the motion information F^{D} by limiting a solution space.

FIG. 3 is a diagram illustrating the internal structure of an optical flow estimator included in a first neural network, according to an embodiment.

Referring to FIG. 3, according to an embodiment, the feature extractor 210 may transmit (or relay) extracted initial motion information (e.g., the initial motion information F^{D,0} of FIG. 2) to the optical flow estimator 250. The optical flow estimator 250 may input the initial motion information (e.g., the initial motion information F^{D,0} of FIG. 2), initial optical flow information (e.g., the initial optical flow information f^{D,0} of FIG. 2), and/or initial distorted information (e.g., the initial distorted information F_{W}^{D,0} of FIG. 2) to a first FRMA block (e.g., the first FRMA block FRMA^{D,1} of FIG. 2) among a plurality of FRMA blocks (e.g., the plurality of FRMA blocks FRMA^{D,1} to FRMA^{D,M} of FIG. 2). The optical flow estimator 250 may refine the input initial motion information F^{D,0}, the input initial optical flow information f^{D,0}, and/or the input initial distorted information F_{W}^{D,0}.

The optical flow estimator 250 may include an FRMA block 340. The FRMA block 340 may be an i+1th FRMA block among the plurality of FRMA blocks FRMA^{D,1} to FRMA^{D,M} Optical flow information fⁱ, motion information Fⁱ, and distorted information F_{W}ⁱ may be information of optical flow information (e.g., the optical flow information f^{D,M} of FIG. 2), first motion information (e.g., the first motion information F^{D,M} of FIG. 2), and distorted information (e.g., the distorted information F_{W}^{D,M} of FIG. 2), respectively. For example, if the FRMA block 340 is the first FRMA block FRMA^{D,1}, the optical flow information f may be the initial optical flow information f^{D,0}, the motion information Fⁱ may be the initial motion information F^{D,0}, and the distorted information F_{W}ⁱ may be the initial distorted information F_{W}^{D,0}.

The motion information Fⁱ is expressed by F∈ [symbol] ^{T×H×W×C}, the distorted information F_{W}ⁱ is expressed by F_{W}∈ [symbol] ^{T×H×W×C}, and the optical flow information f is expressed by f≣{f_{c→(c+t)}^{j},o_{c→(c+t)}^{j}}_{j=1:n}^{t=-N:N}∈ [symbol] ^{T×H×W×(2+1)n}. Here, n denotes the pieces of optical flow information fⁱ from a target image (e.g., the target image X_{C} of FIG. 2) to each of the remaining images (e.g., the remaining images X_{C-N} and X_{C+N} of FIG. 2). The optical flow information fⁱ may include a trainable occlusion mask o_{c→(c+t)}^{j}. The occlusion mask o_{c→(c+t)}^{j} may use a sigmoid activation for stability.

The FRMA block 340 may include a 3D residual dense block (3D RDB). The FRMA block 340 may acquire motion information Fⁱ⁺¹ by inputting the motion information Fⁱ to the 3D RDB. For example, the FRMA block 340 may acquire the motion information Fⁱ⁺¹ through Equation 4.

$${F}^{i + 1} = RDB ( {F}^{i} ) \qquad [ Equation 4 ]$$

The FRMA block 340 may acquire optical flow information fⁱ⁺¹ through Equation 5.

$${f}^{i + 1} = {{f}^{S}}^{} + {Conv}_{3 d} ( concat ( {f}^{S} , W ( {F}^{i + 1} , {f}^{S} ) , {F}_{c}^{0} ) ) \qquad [ Equation 5 ]$$

Here, W denotes occlusion-aware backward warping, concat denotes concatenation along a channel dimension, and F_{c}⁰∈ [symbol] ^{H×W×C} may be motion information on a center image of the initial motion information F⁰.

The initial motion information F⁰ is expressed by F⁰∈ [symbol] ^{T×H×W×C}. For example, the initial motion information F⁰ may include the initial motion information F^{D,0}.

The FRMA block 340 may acquire updated distorted information \tilde{F}_{w}^{S} based on the distorted information F_{W}ⁱ, the optical flow information fⁱ+1, and the motion information Fⁱ⁺¹. For example, the FRMA block 340 may update the distorted information F_{W}ⁱ based on the motion information Fⁱ⁺¹ that an i+1th blurred image among input blurred images is warped as the target image X_{C} by using the optical flow information fⁱ⁺¹. For another example, the FRMA block 340 may acquire the updated distorted information \tilde{F}_{w}^{S} through Equation 6.

$${\tilde{F}}_{w}^{{}_{S}} = {Conv}_{2 d} ( concat ( {F}_{w}^{S} , {r}_{4 \to 3} ( W ( {F}^{i + 1} , {f}^{i + 1} ) ) ) \qquad [ Equation 6 ]$$

Here, r_{4→3} denotes a reshape operation from [symbol] ^{T×H×W×C} to [symbol] ^{H×W×TC} for feature aggregation.

The FRMA block 340 may include a multi-attention block 350. The FRMA block 340 may acquire distorted information F_{W}ⁱ⁺¹ based on the updated distorted information \tilde{F}_{w}^{S}. For example, the FRMA block 340 may acquire the distorted information F_{W}ⁱ⁺¹ by inputting the updated distorted information \tilde{F}_{w}^{S} to the multi-attention block 350.

The multi-attention block 350 may include a center-oriented (CO) attention 351. The multi-attention block 350 may further include a fully connected neural network (FNN) 353.

The CO attention 351 included in the multi-attention block 350 may acquire CO attention information based on the updated distorted information \tilde{F}_{w}^{S} and the initial motion information F_{c}⁰. The CO attention information may include a query Q, a key K, and/or a value V. For example, the query Q may be Q=W_{q}F_{c}⁰, the key K may be K=Wₖ\tilde{F}_{w}^{S}, and the value V may be V=Wᵥ\tilde{F}_{w}^{S}. The CO attention 351 may calculate an attention map based on the query Q and the key K of the CO attention information. The CO attention 351 may adjust the value V based on the calculated attention map.

An initial process for adjusting the value V may be similar to self-attention. The process of adjusting the value V may achieve better performance when the updated distorted information \tilde{F}_{w}^{S} learns its relationship with the initial motion information F_{c}⁰ rather than with the updated distorted information \tilde{F}_{w}^{S} itself.

The CO attention 351 may be expressed by Equation 7.

$$CO Attention ( Q , K , V ) = SoftMax ( {QK}^{T} / \sqrt{d} ) V \qquad [ Equation 7 ]$$

Here, \sqrt{d} may be a scale factor.

The FNN 353 included in the multi-attention block 350 may acquire the distorted information F_{W}ⁱ⁺¹ based on an attention map. For example, the FNN 353 may acquire the distorted information F_{W}ⁱ+1 by receiving the calculated attention map from the CO attention 351.

The multi-attention block 350 may more accurately warp the updated distorted information \tilde{F}_{w}^{S} in the center image through the CO attention 351. The multi-attention block 350 may cause the updated distorted information \tilde{F}_{w}^{S} to effectively learn spatiotemporally changing degradation through the CO attention 351.

FIG. 4 is a diagram illustrating the internal structure of a second neural network for restoring a video, according to an embodiment.

Referring to FIG. 4, according to an embodiment, the second neural network 170 may include the feature extractor 210, an optical flow estimator 450, and/or an image restoration unit 470.

The second neural network 170 may receive a plurality of blurred images X included in the video 110. The plurality of blurred images X input to the second neural network 170 may be the same as a video input to the first neural network 140.

The second neural network 170 may receive optical flow information f^{D,M}, first motion information F^{D,M}, and/or a first kernel K^{D} from the first neural network 140.

The feature extractor 210 included in the second neural network 170 may generate second motion information F^{R,0} to adjust the optical flow information f^{D,M}, based on the plurality of input blurred images X and the first motion information F^{D,M}. For example, the feature extractor 210 may generate the second motion information F^{R,0}, based on concatenation information between the plurality of input blurred images X and the first motion information F^{D,M}.

The feature extractor 210 may include a 3D RRDB. The feature extractor 210 may generate the second motion information F^{R,0} by inputting the concatenation information between the plurality of input blurred images X and the first motion information F^{D,M} to the 3D RRDB. The feature extractor 210 may transmit (or relay) the generated second motion information F^{R,0} to the optical flow estimator 450.

The optical flow estimator 450 may generate dynamic filtering information to filter the plurality of blurred images X, based on the received (or relayed) second motion information F^{R,0}, the optical flow information f^{D,M}, and initial distorted information F_{W}^{R,0}. The dynamic filtering information may include adjusted optical flow information f^{R,M} and/or distorted information F_{W}^{R,M}. The distorted information F_{W}^{R,M} may be the initial distortion information F_{W}^{R,0} having been refined by a plurality of FRMA blocks. The optical flow estimator 450 may transmit (or relay) the generated adjusted optical flow information f^{R,M} and/or the distorted information F_{W}^{R,M} to the image restoration unit 470.

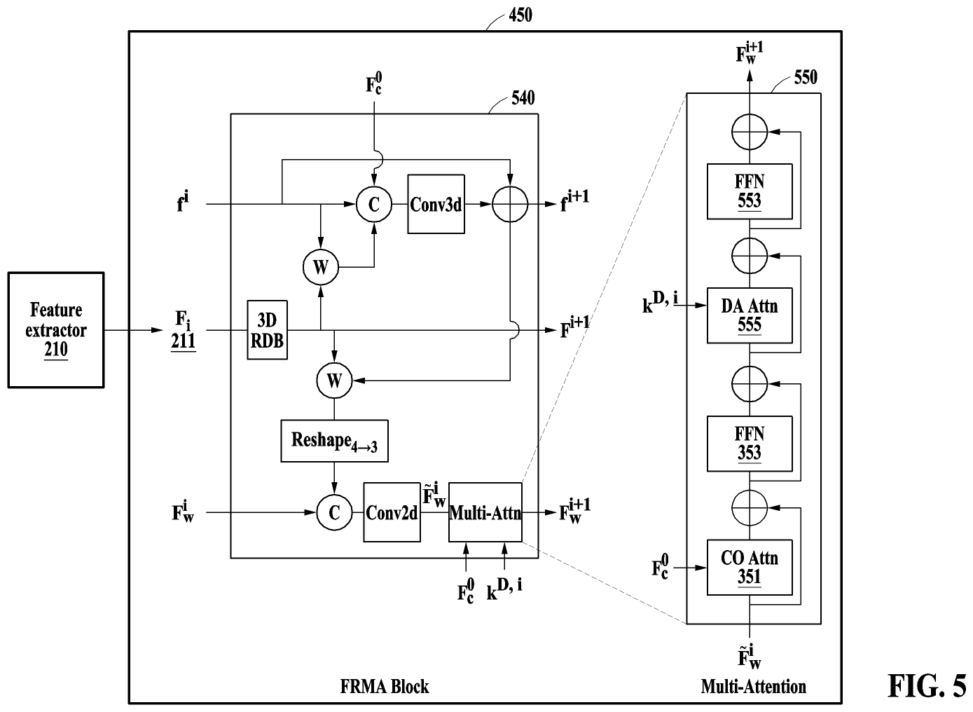

The optical flow estimator 450 may include a plurality of FRMA blocks FRMA^{R,1} to FRMA^{R,M} For example, the optical flow estimator 450 may include M FRMA blocks. The optical flow estimator 450 may input the second motion information F^{R,0} to the first FRMA block FRMA^{R,1} among the plurality of FRMA blocks FRMA^{R,1} to FRMA^{R,M}. The internal structure of the FRMA blocks FRMA^{R,1} to FRMA^{R,M} and the process of each of the optical flow information f^{D,M} and the distorted information F_{W}^{R,M} being iteratively refined by the FRMA blocks FRMA^{R,1} to FRMA^{R,M} are described with reference to FIG. 5.

The optical flow estimator 450 may further include a plurality of 3D convolution blocks 450-1 to 450-m. For example, the optical flow estimator 450 may include M 3D convolution blocks. The number of 3D convolution blocks may be the same as the number of FRMA blocks.

The optical flow estimator 450 may generate a plurality of adjusted kernels k^{D,1} to k^{D,M} based on the first kernel K^{D}. For example, the optical flow estimator 450 may generate the plurality of adjusted kernels k^{D,1} to k^{D,M} by inputting the first kernel K^{D} to the M 3D convolution blocks 450-1 to 450-m. The optical flow estimator 450 may transmit (or relay) the plurality of generated adjusted kernels k^{D,1} to k^{D,M} respectively to the plurality of 3D convolution blocks 450-1 to 450-m. For example, the optical flow estimator 450 may transmit (or relay) the first adjusted kernel k^{D,1} to the first FRMA block FRMA^{R,1}. How the plurality of adjusted kernels k^{D,1} to k^{D,M} is used in the plurality of 3D convolution blocks 450-1 to 450-m is described with reference to FIG. 5.

The image restoration unit 470 may include an FGDF 471. The FGDF 471 may restore the target image X_{C} by filtering the blurred images X, based on the adjusted optical flow information f^{R,M} and the distorted information F_{W}^{R,M} of the received (relayed) dynamic filtering information.

The FGDF 471 may generate a second kernel K^{R} based on the distorted information F_{W}^{R,M}. The second kernel K^{R} may be guided by the adjusted optical flow information f^{R,M} and may be dynamically generated to be aware of a motion pixel-wise. The second kernel K^{R} that is guided by the adjusted optical flow information f^{R,M} may effectively process the motion of an object included in the video 110 even with a small size.

The FGDF 471 may obtain an image flow mask f^{X} for the blurred images X, based on the adjusted optical flow information f^{R,M}. The image flow mask f^{X} may include information on an object motion direction or camera motion direction of the object in the blurred images X. The image flow mask f^{X} may include information on a part hidden (or occluded) by the motion of the object. The information on the hidden (or occluded) part may be information on an occlusion mask. The size of a patch of the image flow mask f^{X} may be the same as the size of a patch of an image flow mask (e.g., the image flow mask f^{Y} of FIG. 2).

The FGDF 471 may warp the each of the blurred images X, based on the adjusted optical flow information f^{R,M}. The FGDF 471 may warp the each of the blurred images X, based on the image flow mask f^{X} obtained based on the adjusted optical flow information f^{R,M}. The FGDF 471 may generate warped images X_{W} by warping the each of the blurred images X.

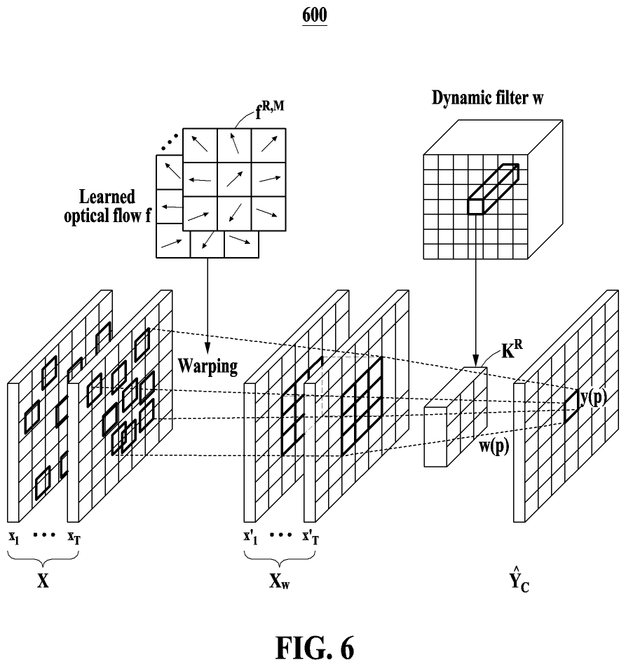

The FGDF 471 may filter the warped images X_{W} using the second kernel K^{R}. The FGDF 471 may obtain a restored image Ŷc restored from the target image X_{C} by filtering the warped images X_{W} through the second kernel K^{R}. The size of a patch of the second kernel K^{R} may be K^{R}∈ [symbol] ^{T×H×W×s}^{²}^{k}^{ᵣ}^{²}. kᵣ may be the size of the second kernel K^{R}. The second kernel K^{R} may have been normalized by using a SoftMax function. The second kernel K^{R} may mimic a deblurring process where kernels have negative values in addition to positive values. The structure of the FGDF 471 is described with reference to FIG. 6.

The image restoration unit 470 may restore high-frequency components Ŷᵣ of the target image X_{C}, based on the distorted information F_{W}^{R,M} For example, the image restoration unit 470 may generate the high-frequency components Ŷᵣ of the target image X_{C} by using stacked convolution and pixel shuffle. The image restoration unit 470 may restore low-frequency components of the target image X_{C} by filtering the warped images X_{W} using the second kernel K^{R}.

The image restoration unit 470 may obtain the restored image Ŷc restored from the target image X_{C} through Equation 8.

$$\hat{Y} c = {\hat{Y}}_{r} + ( W ( X , {f}^{X} ) {K}^{R} ) {↑}_{s} \qquad [ Equation 8 ]$$

Here, \textcircled{*}↓ₛ may be performing dynamic filtering by moving the second kernel K^{R} at every interval s from the position of each pixel according to Equation 1.

Based on the motion information F^{R,M}, the image restoration unit 470 may generate a sharp image \hat{X}_{Sharp}^{R} by removing degradation included in the blurred images X. For example, the image restoration unit 470 may generate the sharp image \hat{X}_{Sharp}^{R} by mapping the motion information F^{R,M} to an image domain via 3D convolution. The motion information F^{R,M} may be the second motion information F^{R,0} refined by the optical flow estimator 450. The sharp image \hat{X}_{Sharp}^{R} may be used to train the second neural network 170. The sharp image \hat{X}_{Sharp}^{R} may be an intermediate output. The sharp image \hat{X}_{Sharp}^{R} may be expressed by \hat{X}_{Sharp}^{R}∈ [symbol] ^{T×H×W×3}.

The second neural network 170 may be trained based on a total loss Lₜₒₜₐₗ. The first neural network 140 may be jointly trained with the second neural network 170, based on the total loss Lₜₒₜₐₗ. The total loss Lₜₒₜₐₗ may be obtained through Equation 9.

$${L}_{total} = {l}_{1} ( {\hat{Y}}_{c} , {Y}_{c} ) + {λ}_{4} {\sum }_{- N}^{+ N} {l}_{1} ( W ( {X}_{t + c} , {f}_{t + c}^{X} ) , {X}_{c} ) + {λ}_{5} {l}_{1} ( {\hat{X}}_{Sharp}^{{}_{R}} , {X}_{Sharp} ) + {λ}_{6} {l}_{D} \qquad [ Equation 9 ]$$

The first term of the right side of Equation 9 may be a reconstruction loss. The second term and the third term may be respectively the same as the second term and the third term of the right side of Equation 3 except for applied domains.

FIG. 5 is a diagram illustrating the internal structure of an optical flow estimator included in a second neural network, according to an embodiment.

Referring to FIG. 5, according to an embodiment, the feature extractor 210 may transmit (or relay) generated second motion information (e.g., the second motion information F^{R,0} of FIG. 4) to the optical flow estimator 450. The optical flow estimator 450 may input optical flow information (e.g., the optical flow information f^{D,M} of FIG. 4), second motion information (e.g., the second motion information F^{R,0} of FIG. 4), and/or initial distorted information (e.g., the initial distorted information F_{W}^{R,0} of FIG. 4) to a plurality of FRMA blocks (e.g., the FRMA blocks FRMA^{R,1} to FRMA^{R,M} of FIG. 4). The optical flow estimator 450 may refine the input optical flow information f^{D,M}, the input second motion information F^{R,0}, and/or the input initial distorted information F_{W}^{R,0}.

The optical flow estimator 450 may include an FRMA block 540. The FRMA block 540 may be an i+1th FRMA block among the plurality of FRMA blocks FRMA^{R,1} to FRMA^{R,M}. Optical flow information fⁱ, motion information Fⁱ, and distorted information F_{W}ⁱ may be information of optical flow information (e.g., the optical flow information f^{R,M} of FIG. 4), motion information (e.g., the motion information F^{R,M} of FIG. 4), and distorted information (e.g., the distorted information F_{W}^{R,M} of FIG. 4), respectively. For example, if the FRMA block 540 is the first FRMA block FRMA^{R,1}, the optical flow information f may be the optical flow information f^{D,M}, the motion information Fⁱ may be the second motion information F^{R,0}, and the distorted information F_{W}ⁱ may be the initial distorted information F_{W}^{R,0}, in which the initial distorted information F_{W}^{R,0} may be 0. The internal structure of the FRMA block 540 may be the same as the internal structure of an FRMA block (e.g., the FRMA block 340 of FIG. 3). For example, the optical flow information fⁱ, the motion information Fⁱ, and the distorted information F_{W}ⁱ that are input to the FRMA block 540 may be respectively the same as the optical flow information fⁱ, the motion information Fⁱ, and the distorted information F_{W}ⁱ that are input to the FRMA block 340. For another example, distorted information \tilde{F}_{w}^{S} updated based on motion information Fⁱ⁺¹, optical flow information fⁱ⁺¹, and the distorted information F_{W}ⁱ input to the FRMA block 340 may be the same as distorted information \tilde{F}_{w}^{S} updated based on the motion information Fⁱ⁺¹, the optical flow information fⁱ⁺¹, and the distorted information F_{W}ⁱ input to the FRMA block 540.

The FRMA block 540 may include a multi-attention block 550. The FRMA block 540 may acquire distorted information Fⁱ⁺¹ based on the updated distorted information \tilde{F}_{W}^{S}. For example, the FRMA block 540 may acquire the distorted information F_{W}ⁱ⁺¹ by inputting the updated distorted information \tilde{F}_{W}^{S} to the multi-attention block 550.

The multi-attention block 550 may include the CO attention 351 and/or a degradation-aware (DA) attention 555. The multi-attention block 550 may further include one or more FNNs 353 and 553.

The FNN 353 included in the multi-attention block 550 may acquire distorted information (not shown) to which nonlinear transformation is applied, based on an attention map. For example, the distorted information to which nonlinear transformation is applied may include distorted information transformed based on a sigmoid activation function.

The DA attention 555 included in the multi-attention block 550 may acquire DA attention information based on the distorted information to which nonlinear transformation is applied and an adjusted kernel k^{D,i} obtained from a first kernel (e.g., the first kernel K^{D} of FIG. 2). The DA attention information may include a query Q, a key K, and/or a value V. For example, the query Q may be Q=W_{q}k^{D,i}, the key K may be K=Wₖ\tilde{F}_{w}^{S}, and the value V may be V=Wᵥ\tilde{F}_{W}^{S}. The adjusted kernel k^{D,i} may be expressed by k^{D,i}∈ [symbol] ^{H×W×C}. The DA attention 555 may calculate an attention map based on the query Q and the key K of the DA attention information. The DA attention 555 may adjust the value V based on the calculated attention map.

An initial process for adjusting the value V may be similar to self-attention. The process of adjusting the value V may achieve better performance when the updated distorted information \tilde{F}_{W}^{S} learns its relationship with the initial motion information F_{c}⁰ rather than with the updated distorted information \tilde{F}_{W}^{S} itself.

The DA attention 555 the same as the CO attention 351 may be expressed by Equation 6.

The FNN 553 included in the multi-attention block 550 may acquire the distorted information F_{W}ⁱ⁺¹ based on the attention map. The multi-attention block 550 may cause the updated distorted information \tilde{F}_{W}^{S} to be globally adaptive to degradation included in blurred images (e.g., the blurred images X of FIG. 4) through the DA attention 555.

FIG. 6 is a diagram illustrating the structure of an FGDF, according to an embodiment.

Referring to FIG. 6, according to an embodiment, an FGDF 600 may be the same as an FGDF (e.g., the FGDF 471 of FIG. 4). The FGDF 600 may receive blurred images X. In addition, the FGDF 600 may receive adjusted optical flow information f^{R,M} from an optical flow estimator (e.g., the optical flow estimator 450 of FIG. 4).

The FGDF 600 may warp each of the blurred images X, based on the adjusted optical flow information f^{R,M}. The FGDF 600 may generate warped images X_{W} by warping the each of the blurred images X.

The FGDF 600 may include a second kernel K^{R}. The FGDF 600 may filter the warped images X_{W} through the second kernel K^{R}. The FGDF 600 may generate a restored image Ŷc restored from a target image (e.g., the target image X_{C} of FIG. 4) by filtering the warped images X_{W} using the second kernel K^{R}.

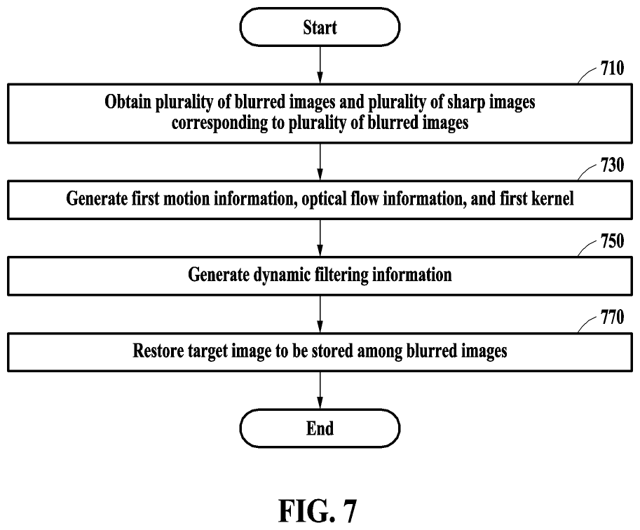

FIG. 7 is a flowchart illustrating a method of restoring a video, according to an embodiment. Operations 710 to 770 may be sequentially performed but not necessarily. For example, operations 710 and 730 may be parallelly performed, or operation 730 may be performed prior to operation 710. Operations 710 to 770 may be substantially the same as the operations of the above-described video restoration unit (e.g., the video restoration unit 100 of FIG. 1), and thus the repeated description thereof is omitted.

In operation 710, the video restoration unit 100 may obtain a plurality of blurred images X_{c-N}, X_{c}, and X_{c+N} due to motions of an object captured in the video (e.g., the video 110 of FIG. 1) and a plurality of sharp images (e.g., the plurality of sharp images Y of FIG. 2) corresponding to the plurality of blurred images X_{c-N}, X_{c}, and X_{c+N}.

In operation 730, based on the blurred images X_{c-N}, X_{c}, and X_{c+N} included in the video 110, the video restoration unit 100 may generate a first kernel (e.g., the first kernel K^{D} of FIG. 2) to filter the sharp images Y, optical flow information (e.g., the optical flow information f^{D,M} of FIG. 4) on an object motion direction or camera motion direction, and first motion information (e.g., the first motion information F^{D,M} of FIG. 4) of the object included in the blurred images X_{c-N}, X_{c}, and X_{c+N}.

In operation 750, the video restoration unit 100 may generate dynamic filtering information to filter the blurred images X_{c-N}, X_{c}, and X_{c+N}, based on the first kernel K^{D}, the optical flow information f^{D,M}, the first motion information F^{D,M}, the blurred images X_{c-N}, X_{c}, and X_{c+N}.

In operation 770, the video restoration unit 100 may restore a target image (e.g., the target image X_{c} of FIG. 4) to be restored among the plurality of the blurred images X_{c-N}, X_{c}, and X_{c+N} and the dynamic filtering information.

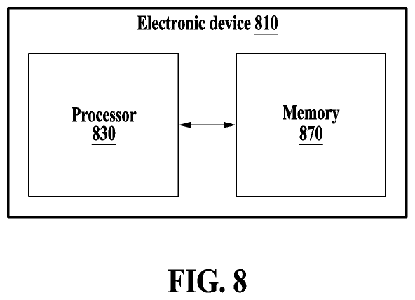

FIG. 8 is a block diagram illustrating a video restoration unit according to an embodiment.

Referring to FIG. 8, according to an embodiment, an electronic device 810 (e.g., the video restoration unit 100 of FIG. 1) may include a processor 830 and a memory 870.

The memory 870 may store instructions (or programs) executable by the processor 830. For example, the instructions may include instructions for executing an operation of the processor 830 and/or an operation of each component of the processor 830.

The memory 870 may include one or more computer-readable storage media. The memory 870 may include non-volatile storage elements (e.g., a magnetic hard disk, an optical disc, a floppy disc, a flash memory, an electrically programmable memory (EPROM), and an electrically erasable and programmable memory (EEPROM)).

The memory 870 may be non-transitory media. The term “non-transitory” may indicate that a storage medium is not embodied in a carrier wave or a propagated signal. However, the term “non-transitory” should not be interpreted to mean that the memory 870 is non-movable.

The processor 830 may process data stored in the memory 870. The processor 830 may execute computer-readable code (e.g., software) stored in the memory 870 and instructions triggered by the processor 830.

The processor 830 may be a hardware-implemented data processing device including a circuit that is physically structured to execute desired operations. For example, the desired operations may include code or instructions included in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The host processor 830 may generally control the electronic device 810 by executing programs and/or instructions stored in the memory 870. Operations performed by the electronic device 810 may be substantially the same as the operations performed by the video restoration unit 100 described with reference to FIGS. 1 to 7. Accordingly, the repeated description thereof is omitted.

The examples described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a FPGA, a programmable logic unit (PLU), a microprocessor, or any other device capable of responding to and executing instructions in a defined manner. The processing device may run an operating system (OS) and one or more software applications that run on the OS. The processing unit also may access, store, manipulate, process, and generate data in response to execution of the software. For purpose of simplicity, the description of a processing unit is used as singular; however, one skilled in the art will appreciate that a processing unit may include multiple processing elements and multiple types of processing elements. For example, the processing unit may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random-access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

1. A method of restoring a video, the method comprising:
obtaining a plurality of blurred images due to object motion and camera motion of an object captured in the video;
generating a first kernel comprising degradation information on the plurality of blurred images, optical flow information on the plurality of blurred images, and first motion information on each of the plurality of blurred images comprised in the video;
generating dynamic filtering information to filter the plurality of blurred images, based on the plurality of blurred images, the first motion information, the optical flow information, and the first kernel; and
restoring a target image to be restored among the plurality of blurred images, based on the dynamic filtering information and the plurality of blurred images.

2. The method of claim 1, wherein the generating the dynamic filtering information comprises:
generating second motion information to adjust the optical flow information, based on the plurality of blurred images and the first motion information;
adjusting the optical flow information, based on the second motion information, the optical flow information, and the first kernel; and
generating distorted information on how distorted each of the remaining images excluding the target image is with respect to the target image, based on the second motion information, the optical flow information, and the first kernel, wherein the dynamic filtering information comprises adjusted optical flow information and the distorted information.

3. The method of claim 2, wherein the restoring the target image comprises restoring the target image by filtering the plurality of blurred images, based on the adjusted optical flow information and the distorted information.

4. The method of claim 3, wherein the restoring the target image further comprises:
warping the objects comprised in each of the plurality of blurred images, based on the adjusted optical flow information;
generating a second kernel to filter warped images obtained by warping the objects, based on the distorted information; and
restoring the target image by filtering the warped images using the second kernel.

5. The method of claim 4, wherein the restoring the target image by filtering the warped images using the second kernel comprises restoring low-frequency components of the target image.

6. The method of claim 5, further comprising restoring high-frequency components of the target image, based on the distorted information.

7. An electronic device comprising:
a memory comprising instructions; and
a processor electrically connected to the memory and configured to execute the instructions, wherein the instructions, when executed by the processor, cause the electronic device to:
obtain a plurality of blurred images due to object motion and camera motion captured in a video,
generate a first kernel comprising degradation information on the plurality of blurred images, optical flow information on the plurality of blurred images, and first motion information on each of the plurality of blurred images comprised in the video,
generate dynamic filtering information to filter the plurality of blurred images, based on the plurality of blurred images, the first motion information, the optical flow information, and the first kernel, and
restore a target image to be restored among the plurality of blurred images, based on the dynamic filtering information and the plurality of blurred images.

8. The electronic device of claim 7, wherein the instructions, when executed by the processor, cause the electronic device to
generate second motion information to adjust the optical flow information, based on the plurality of blurred images and the first motion information,
adjust the optical flow information, based on the second motion information, the optical flow information, and the first kernel, and
generate distorted information on how distorted each of the remaining images excluding the target image is with respect to the target image, based on the second motion information, the optical flow information, and the first kernel.

9. The electronic device of claim 8, wherein the instructions, when executed by the processor, cause the electronic device to restore the target image by filtering the plurality of blurred images, based on adjusted optical flow information and the distorted information.

10. The electronic device of claim 9, wherein the instructions, when executed by the processor, cause the electronic device to
warp the object comprised in each of the plurality of blurred images, based on the adjusted optical flow information,
generate a second kernel to filter warped images obtained by warping the object, based on the distorted information, and
restore the target image by filtering the warped images using the second kernel.

11. The electronic device of claim 10, wherein the instructions, when executed by the processor, cause the electronic device to restore low-frequency components of the target image.

12. The electronic device of claim 11, wherein the instructions, when executed by the processor, cause the electronic device to restore high-frequency components of the target image, based on the distorted information.
